(19) United States
(12) Patent Application Publication
(10) Pub. No.: US 2017/0074029 A1
(43) Pub. Date: Mar. 16, 2017

(54) Glazing Bead for Engaging a Fenestration Article and a Frame, and a Method of Producing the Same

(71) Applicant: Quanex Homeshield, LLC, Mounds View, MN (US)

(72) Inventors: Scott M. Fetting, Rice Lake, WI (US); Michael Herlihy, Seattle, WA (US); Joe Traynor, Seattle, WA (US); Jeff Franson, Bothell, WA (US); Grant T. Muller, Kent, WA (US)

(21) Appl. No.: 15/266,029

(22) Filed: Sep. 15, 2016

Related U.S. Application Data
(60) Provisional application No. 62/218,837, filed on Sep. 15, 2015.

(51) Int. Cl. E06B 3/58; B32B 17/06; B29D 12/00; B29C 47/00; B29C 47/02; E06B 3/54; B32B 7/14

(52) U.S. Cl. CPC E06B 3/5821; E06B 3/5409; B32B 17/06; B32B 7/14; B29C 47/004; B29C 47/02; B29D 12/00; E06B 3/06

(57) ABSTRACT

A glazing bead engages a fenestration article and a frame. The glazing bead includes a reinforcement member, at least a portion of which extends along a cross-sectional axis in a substantially linear configuration between a first end and a second end. The glazing bead includes a body at least partially enveloping the reinforcement member and coupled with the reinforcement member. The glazing bead includes a protrusion extending from the body adjacent the first end and a leg having a proximal end adjacent the second end, with the leg extending from the body to a distal end, with the proximal and distal ends forming an angle less than ninety degrees from the cross-sectional axis. A method of manufacturing the glazing member includes steps of providing the reinforcement member and depositing a polymer to form the body, the protrusion, and the leg coupled with the reinforcement member.

### BACKGROUND OF THE INVENTION

1. Field of the Invention

The subject invention relates to a glazing bead for engaging a fenestration article and a frame, and a method of producing the glazing bead.

2. Description of Related Art

Glazing beads are used in fenestration systems to engage a glass panel and a frame. The frame has rails and stiles arranged end-to-end to form a closed rectangular configuration. The rails and the stiles are disposed about a perimeter of the glass panel. Glazing beads are arranged end-to-end with each glazing bead extending independently along the rails and the stiles. The glazing beads are retained by the rails and the stiles and couple the glass panel to the rails and stiles.

Traditionally, the glazing bead is integrally formed of polyvinyl chloride (PVC). The glazing bead is subjected to high temperatures from the sun. The high temperatures can cause the PVC to warp and shrink, which causes the glazing bead to pull away from the glass panel. Pulling away of the glazing bead causes a discontinuous coupling along the rails and the stiles which can result in the glazing bead being unstable in the frame. Furthermore, the pulling away of the glazing bead causes a transition between the rail/stile and the glass panel which is not aesthetically pleasing. As such, there remains a need to provide an improved glazing bead.

### SUMMARY OF THE INVENTION AND ADVANTAGES

The subject invention provides for a glazing bead for engaging a fenestration article and a frame. The glazing bead includes a reinforcement member having an outer surface and extending along a longitudinal axis between a pair of longitudinal ends, with at least a portion of the reinforcement member extending along a cross-sectional axis, which is transverse to the longitudinal axis, in a substantially linear configuration between a first end and a second end. The glazing bead further includes and a body at least partially enveloping the outer surface of the reinforcement member and coupled with the reinforcement member, with the body supported by the reinforcement member. The glazing bead further includes a protrusion extending from the body adjacent the first end of the reinforcement member for engaging the fenestration article, and a leg having a proximal end adjacent the second end of the reinforcement member, with the leg extending from the body to a distal end, with the proximal and distal ends forming an angle less than ninety degrees from the cross-sectional axis for engaging the frame such that the leg is retained by the frame.

The subject invention further provides a method of manufacturing a glazing bead for engaging a fenestration article and a frame. The glazing bead includes a reinforcement member having an outer surface and extending along a longitudinal axis between a pair of longitudinal ends, with at least a portion of the reinforcement member extending along a cross-sectional axis, which is transverse to the longitudinal axis, in a substantially linear configuration between a first end and a second end. The glazing bead further includes a body at least partially enveloping the outer surface of the reinforcement member and coupled with the reinforcement member, with the body supported by the reinforcement member. The glazing bead further includes a leg having a proximal end adjacent the second end of the reinforcement member, with the leg extending from the body to a distal end. The proximal and distal ends form an angle less than ninety degrees from the cross-sectional axis. The method includes the steps of providing the reinforcement member, and depositing a polymer to form the body, the protrusion, and the leg coupled with the reinforcement member.

Accordingly, the reinforcement member supports the body of the glazing bead. The reinforcement member prevents excessive warping of the glazing bead due to direct heating from the sun, which maintains engagement with the fenestration article and the frame, which provides a seal between the fenestration article and the frame.

### BRIEF DESCRIPTION OF THE DRAWINGS

Advantages of the subject invention will be readily appreciated as the same becomes better understood by reference to the following detailed description when considered in connection with the accompanying drawings.

FIG. 1 is a perspective view of a frame, a fenestration article, and a plurality of glazing beads.

FIG. 2A is cross-sectional, perspective view of a glazing bead having a reinforcement member, a body, a protrusion, a leg, and a cap.

FIG. 2B is a cross-sectional view of the glazing bead shown in FIG. 2A.

FIG. 2C is a cross-sectional view of a frame, a fenestration article, and the glazing bead shown in FIG. 2A.

FIG. 3A is a cross-sectional view of a glazing bead having a protrusion extending beyond a leg.

FIG. 3B is a cross-sectional view of a frame, a fenestration article, and the glazing bead shown in FIG. 3A.

FIG. 4A is a cross-sectional view of a glazing bead having a leg extending inwardly toward a first end of a reinforcement member.

FIG. 4B is a cross-sectional view of a frame, a fenestration article, and the glazing bead shown in FIG. 4A.

FIG. 5A is a cross-sectional view of a glazing bead having a protrusion extending inwardly toward a second end of a reinforcement member.

FIG. 5B is a cross-sectional view of a frame, a fenestration article, and the glazing bead shown in FIG. 5A.

FIG. 6A is a cross-sectional view of a glazing bead having a leg extending inwardly toward a first end of a reinforcement member, a protrusion extending outwardly away from a body, and a cap disposed on the body and the protrusion.

FIG. 6B is a cross-sectional view of a frame, a fenestration article, and the glazing bead shown in FIG. 6A.

FIG. 7 is a cross-sectional view of a glazing bead having a protrusion extending beyond a leg, a cap disposed on the leg, and a reinforcement member disposed in the protrusion.

FIG. 8 is a cross-sectional view of a glazing bead having a leg extending inwardly toward a first end of a reinforcement member, a protrusion extending outwardly away from a body, and a reinforcement member disposed in the protrusion.

FIG. 9 is a cross-sectional view of a glazing bead having a reinforcement member disposed in a protrusion and a leg extending inwardly toward a first end of the reinforcement member.

FIG. 10 is a cross-sectional view of a glazing bead having a leg extending inwardly toward a first end of a reinforcement member and a protrusion extending outwardly away from a body.

FIG. 11 is a cross-sectional view of a glazing bead having a leg extending inwardly toward a first end of a reinforcement member, a protrusion extending outwardly away from a body, and a reinforcement member disposed in the protrusion.

FIG. 12 is a cross-sectional view of the reinforcement member shown in FIG. 2A in an initial configuration and having a pretreated layer and a structural layer.

FIG. 13 is a cross-sectional view of the reinforcement member, the body, the protrusion, and the leg shown in FIG. 2A in a final configuration.

FIG. 14 is a cross-sectional view of a portion of a reinforcement member and a body with a pretreated layer of the reinforcement member integral with a structural layer of the reinforcement member and the body.

### DETAILED DESCRIPTION OF THE INVENTION

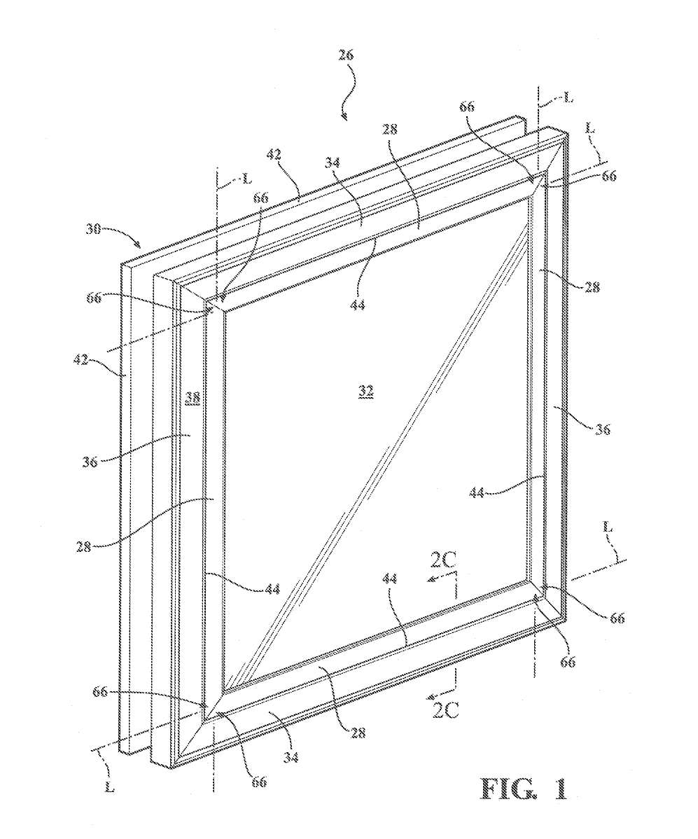

Referring to the Figures, wherein like numerals indicates like or corresponding parts throughout the several views, a fenestration closure assembly 26 for disposition within an opening of a structure is generally shown in FIG. 1. The structure may be a building, a house, or any other suitable structure with an opening. The fenestration closure assembly 26 is configured to cover the opening. The fenestration closure assembly 26 may be defined as, or partially define, a door or a window, or any other suitable component received by the opening. Alternatively, the fenestration closure assembly 26 may cover the opening while disposed on the structure itself. The fenestration closure assembly 26 may be used to replace a lost or damaged fenestration closure assembly 26. Furthermore, the fenestration closure assembly 26 may be originally supplied by a manufacturer of the fenestration closure assembly 26. The fenestration closure assembly 26 may be provided in a kit or with the door or window to be disposed in the structure.

As shown in FIG. 1, the frame 30 includes a pair of rail members 34 and a pair of stile members 36. Each of the rail members 34 are spaced from each other and each of the stile members 36 are spaced from each other. The pair of rail members 34 is coupled with the pair of stile members 36. The rail members 34 may be transverse to the stile members 36, thereby presenting a rectangular configuration of the frame 30. However, the frame 30 may define any suitable quadrilateral configuration, including, but not limited to, a trapezoidal configuration, and the like.

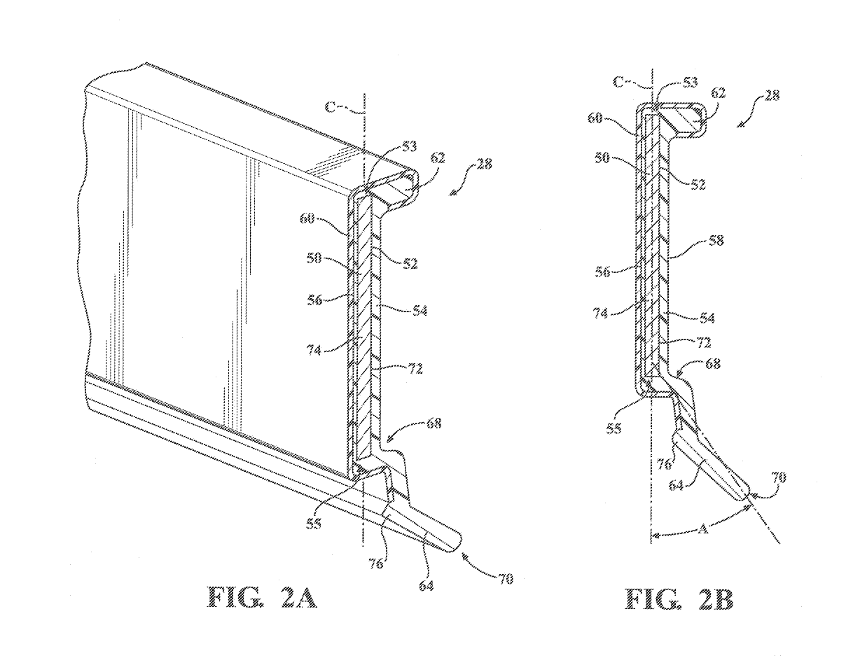

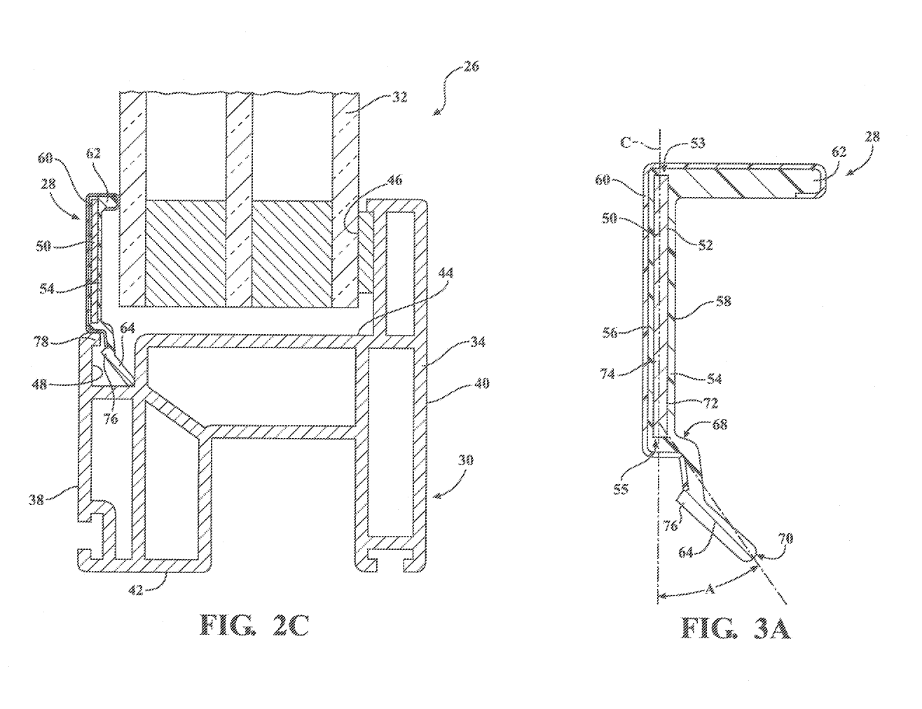

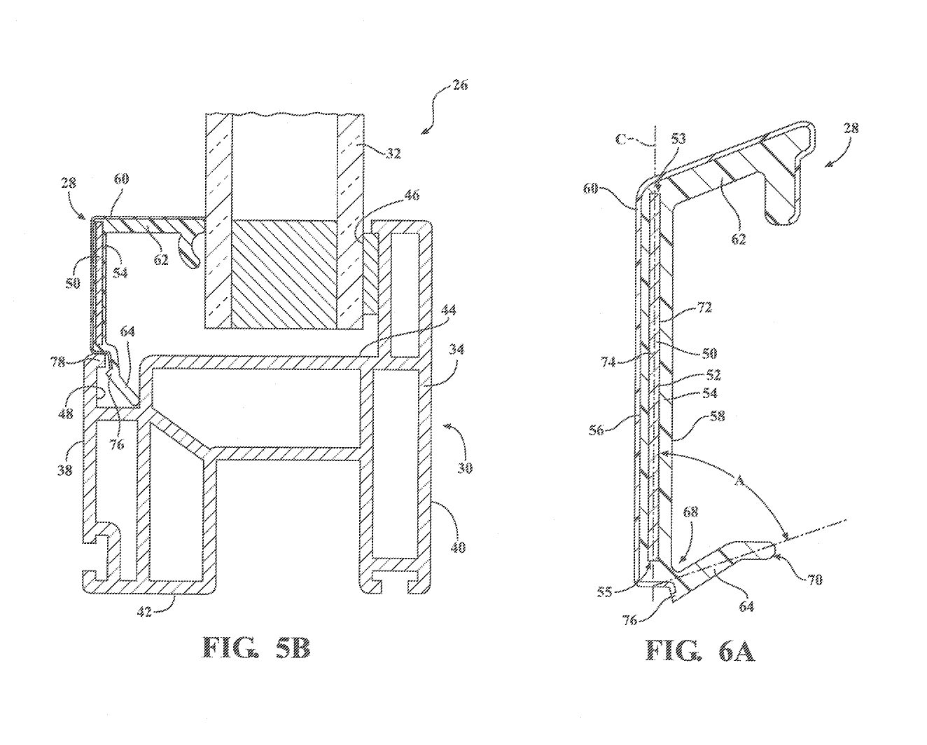

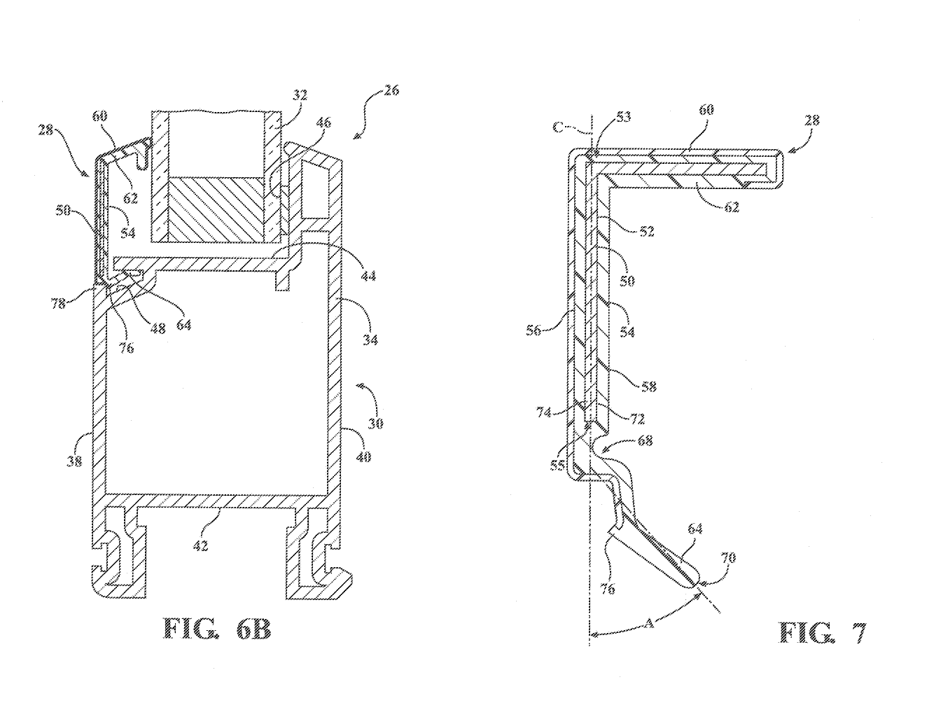

The rail members 34 are often mirror images of each other and the stile members 36 are often mirror images of each other. The rail members 34 and the stile members 36 each have a cross-section. The cross-section of each of the rail members 34 may be substantially similar to the cross-section of each of the stile members 36. As such, the cross-sectional views shown in FIGS. 2C, 3B, 4B, 5B, and 6B indicate a common component as both the rail member 34 and the stile member 36, indicating that the configuration of the frame 30 shown therein is applicable to both the rail member 34 and the stile member 36.

As shown in FIGS. 2C, 3B, 4B, 5B, and 6B, the rail members 34 and the stile members 36 each have an exterior wall 38 and an interior wall 40 opposite the exterior wall 38. The interior wall 40 of each of the rail members 34 and each of the stile members 36 may face an interior of the structure when the frame 30 is disposed on the structure. The exterior wall 38 of each of the rail members 34 and each of the stile members 36 is visible from an exterior of the structure when the frame 30 is disposed on the structure.

The rail members 34 and the stile members 36 each further include an outer wall 42 and an inner wall 44 opposite the outer wall 42. Both the outer wall 42 and the inner wall 44 are disposed between the interior wall 40 and the exterior wall 38. Generally, the outer walls 42 of the rail members 34 and stile members 36 define a periphery of the frame 30. The exterior wall 38, the interior wall 40, the outer wall 42, and the inner wall 44 collectively define the cross-section of each of the rail members 34 and each of the stile members 36. Each of the rail members 34 and the stile members 36 may define an interior such that the rail members 34 and the stile members 36 may be hollow.

Each of the rail members 34 and the stile members 36 may have an abutment surface 46 spaced from and facing the same direction as the exterior wall 38. The fenestration closure assembly 26 may further include a fenestration article 32 coupled to the frame 30. The fenestration article 32 may engage the abutment surface 46, preventing further movement of the fenestration article 32 beyond the abutment surface 46 into the interior of the structure. Moreover, the fenestration article 32 may be coupled to the frame 30 at the abutment surface 46 by adhesive, mechanical fastener, or any other suitable manner of coupling.

The fenestration article 32 may be a glass panel as shown in FIG. 1. However, the frame 30 may support other fenestration articles 32, such as a screen cloth, and the like. The fenestration article 32 may be substantially transparent and may be configured to reflect ultraviolet light. The fenestration article 32 may also be decorative and include a symbol and/or decorative image formed thereon.

As shown in FIGS. 2C, 3B, 4B, 5B, and 6B, each of the rail members 34 and the stile members 36 may define a retention channel 48 adjacent the exterior wall 38. The retention channel 48 may be spaced from the abutment surface 46. The purpose of the retention channel 48 will be better understood through further description below.

The fenestration closure assembly may further include a glazing bead 28 for engaging a fenestration article 32 and a frame 30. As shown in FIG. 1, the glazing bead 28 may extend along one of the rail members 34 of the frame 30 between the stile members 36 coupled to the rail member 34. Alternatively, the glazing bead 28 may extend along one of the stile members 36 of the frame 30 between the rail members 34 coupled to the stile member 36. The glazing bead 28 may be a plurality of glazing beads 28 with each glazing bead 28 independently extending along one of the rail members 34 and the stile members 36. For example, when the frame 30 includes a pair of rail members 34 and a pair of stile members 36 defining a rectangular configuration as described above, the glazing bead 28 may be four glazing beads 28 each independently extending along the pair of rail members 34 and the pair of stile members 36. It is to be appreciated that the glazing bead 28 may be any number of glazing beads 28.

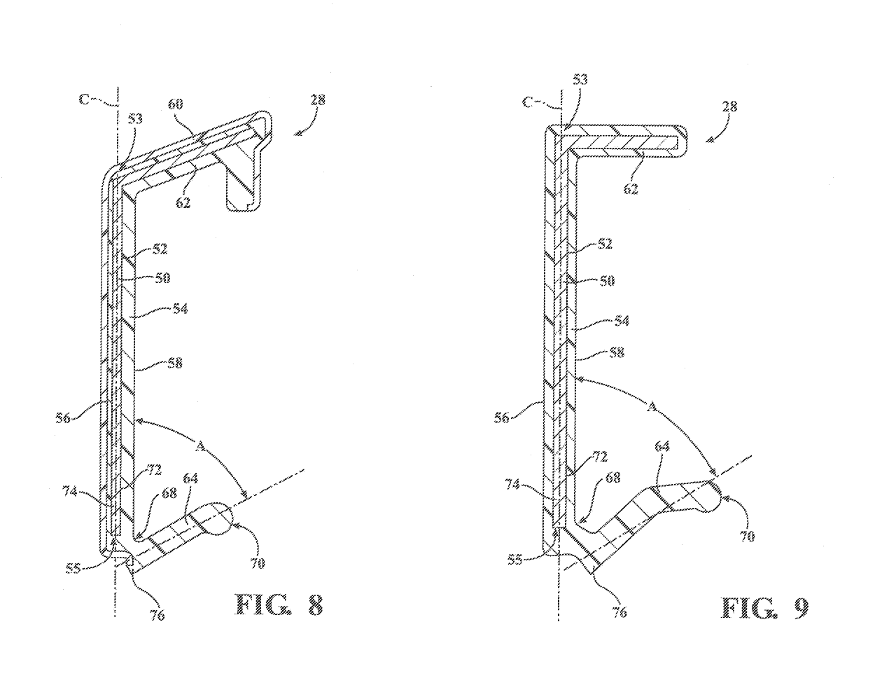

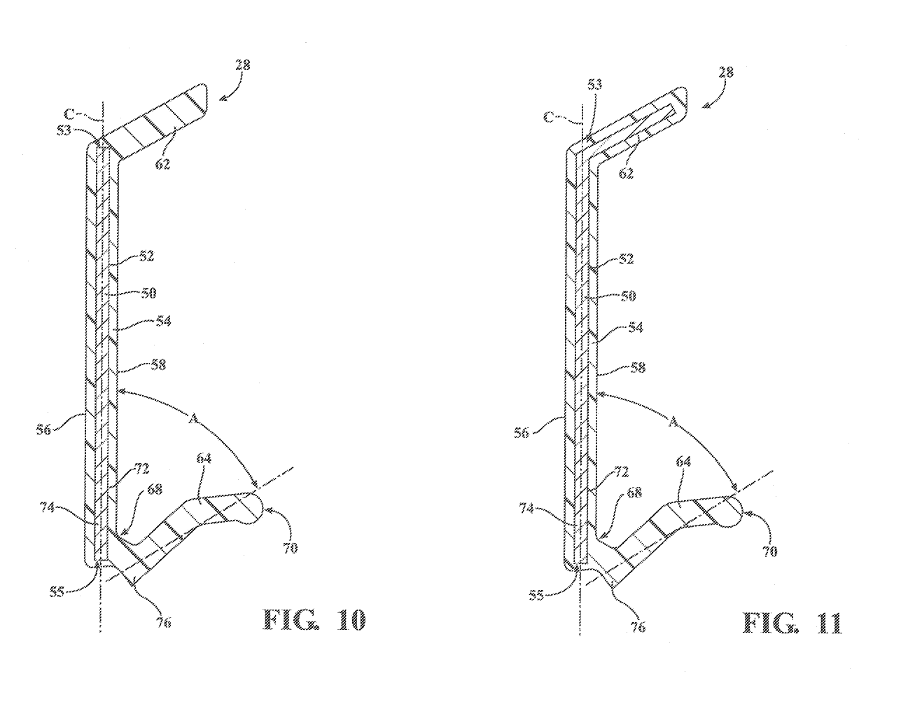

As generally shown in FIGS. 2A-11, the glazing bead 28 includes a reinforcement member 50 having an outer surface 52 and extending along a longitudinal axis L between a pair of longitudinal ends 66, with at least a portion of the reinforcement member 50 extending along a cross-sectional axis C, which is transverse to the longitudinal axis L, in a substantially linear configuration between a first end 53 and a second end 55. The glazing bead 28 further includes and a body 54 at least partially enveloping the outer surface 52 of the reinforcement member 50 and coupled with the reinforcement member 50, with the body 54 supported by the reinforcement member 50. The glazing bead 28 further includes a protrusion 62 extending from the body 54 adjacent the first end 53 of the reinforcement member 50 for engaging the fenestration article 32, and a leg 64 having a proximal end 68 adjacent the second end 55 of the reinforcement member 50, with the leg 64 extending from the body 54 to a distal end 70, with the proximal and distal ends 68, 70 forming an angle A less than ninety degrees from the cross-sectional axis C for engaging the frame 30 such that the leg 64 is retained by the frame 30.

Engagement of the glazing bead 28 with the frame 30 and the fenestration article 32 may provide a seal between frame 30 and the fenestration article 32, to prevent intrusion heat and water transmission between the frame 30 and the fenestration article 32.

The body 54 may have an exterior surface 56 configured to face away from the fenestration article 32 and an interior surface 58 configured to face toward the fenestration article 32 such that the interior surface 58 opposes the exterior surface 56 along the cross-sectional axis C. The glazing bead 28 may further include a cap 60 disposed on the exterior surface 56 of the body 54 for covering the body 54 when the glazing bead 28 is assembled with the fenestration article 32 and the frame 30,

As shown in FIG. 1, the body 54 may extend along and be coupled with the reinforcement element continuously between and at the pair of longitudinal ends 66 for supporting the body 54 between and at the pair of longitudinal ends 66. Said differently, the body 54 may extend between the pair of longitudinal ends 66 without any breaks between the pair of longitudinal ends 66. Furthermore, the cap 60, the protrusion 62, and the leg 64 may extend between the pair of longitudinal ends 66 without any breaks between the pair of longitudinal ends 66. However, it is to be appreciated that the body 54, the cap 60, the protrusion 62, and the leg 64 may be discontinuous (i.e., may be segmented) between the pair of longitudinal ends 66. The body 54, the cap 60, the protrusion 62, and the leg 64 may truncate at the longitudinal ends 66 of the reinforcement member 50. It is to be appreciated that the body 54, the cap 60, the protrusion 62, and the leg 64 may extend beyond one or both of the pair of longitudinal ends 66 of the reinforcement member 50.

The reinforcement member 50 may be disposed within at least one of the protrusion 62 and the leg 64. Said differently, the reinforcement member 50 may extend into at least one of the protrusion 62 and the leg 64 as shown in FIGS. 7, 8, 9, and 11. As such, the reinforcement member 50 may be bent to extend into at least one of the protrusion 62 and the leg 64. Alternatively, the reinforcement member 50 may be a plurality of reinforcement members 50, with the reinforcement members 50 being disposed in the body 54 and at least one of the protrusion 62 and the leg 64.

As shown in FIGS. 2A-11, the protrusion 62 may extend from the interior surface 58 of the body 54. Likewise, the leg 64 may extend from the interior surface 58 of the body 54. Alternatively, the protrusion 62 and the leg 64 may extend from the exterior surface 56 of the body 54.

As shown in FIGS. 2A-11, the protrusion 62 may be transverse to the body 54 extending along the cross-sectional axis C. Furthermore, the protrusion 62 may be substantially perpendicular to the body 54 relative to the cross-sectional axis C, as shown in FIGS. 2A-3B, 7, and 9. It is to be appreciated that the protrusion 62 may extend from the body 54 at any suitable angle.

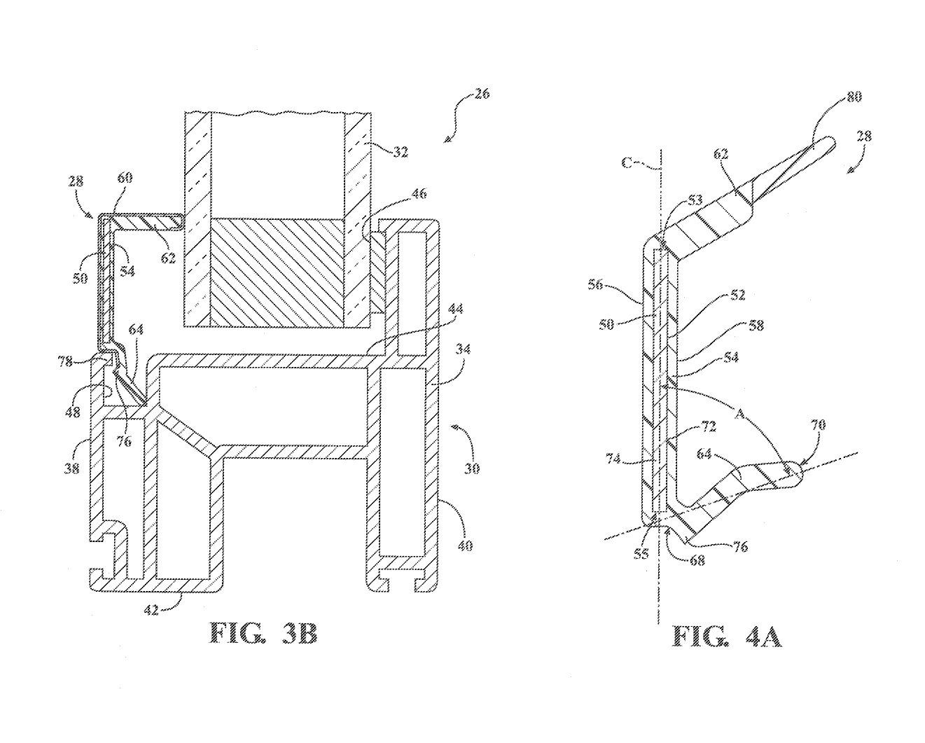

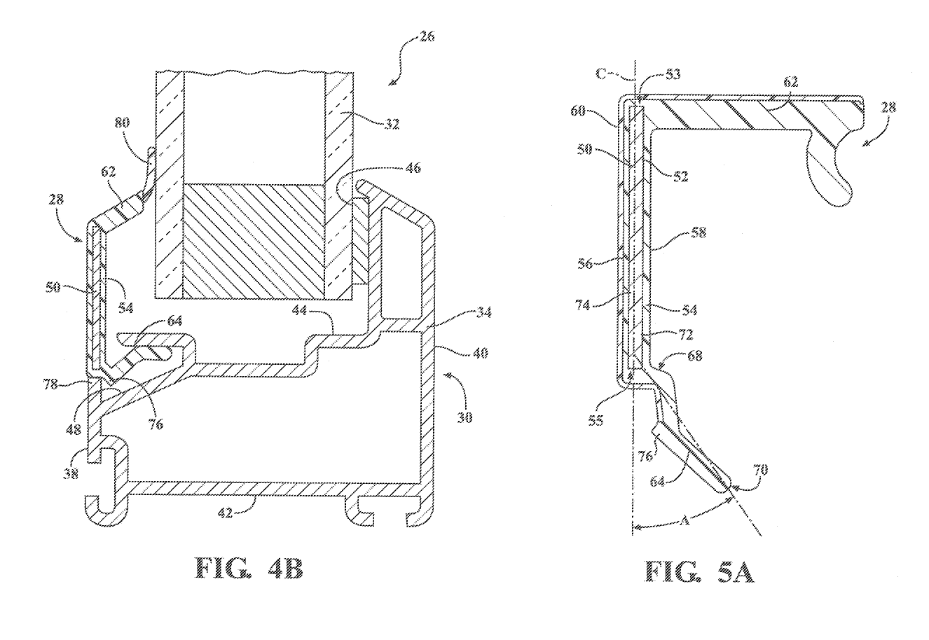

As shown in FIGS. 4A and 4B, the protrusion 62 may have a tip 80 for engaging the fenestration article 32. The tip 80 may be comprised of a soft-durometer rubber, or any other suitable material, for sealing against the fenestration article 32.

As shown in FIGS. 2A-11, the leg 64 may be transverse to the body 54 relative to the cross-sectional axis C. More specifically, the leg 64 may be angled outwardly away from the body 54 as shown in FIGS. 2A-3B, 5A, 5B, and 7. Alternatively, the leg 64 may be angled inwardly toward the first end 53 of the reinforcement member 50, as shown in FIGS. 4A, 4B, 6A, 6B, and 8-11. It is to be appreciated that the leg 64 may extend from the body 54 at any suitable angle A.

As shown in FIGS. 2A-11, the leg 64 may have a plurality of portions integral with one another and extending in series between the proximal and distal ends 68, 70 with the portions positioning the distal end 70 relative to the proximal end 68. As such, the proximal and distal ends 68, 70 form the angle A.

As shown in FIGS. 2C, 3B, 4B, 5B, and 6B, the protrusion 62 engages the fenestration article 32. As such, the protrusion 62 of the glazing bead 28 and the abutment surface 46 of the respective rail member 34 or stile member 36 sandwiches the fenestration article 32 therebetween. The leg 64 extends into the retention channel 48 and engages the respective rail member 34 or stile member 36 within the retention channel 48. The configuration of the leg 64 and the configuration of the retention channel 48 facilitate retention of the leg 64 within the channel, which couples the glazing bead 28 to the respective rail member 34 or stile member 36 and maintains engagement of the glazing bead 28 with the fenestration article 32. More specifically, the leg 64 may have a projection 76 between the proximal and distal ends 68, 70, with the projection 76 opposing the distal end 70 for engaging the frame 30 with each of the distal end 70 and the projection 76. As such, the projection 76 and the distal end 68 may engage opposing sides of the rail member 34 or the stile member 36 in the retention channel 48 such that the leg 64 frictionally engages the rail member 34 or the stile member 36. Moreover, the rail member 34 or the stile member 36 may further include a protuberance 78 extending into the retention channel 48 and engageable with one of the projection 76 and the distal end 70 to further retain the leg 74 in the retention channel 48 and thus couple the glazing bead 28 to the frame 30. As shown in the Figures, the projection 76 may have an angular configuration. The angular configuration may ensure more surface area in contact with rail member 34 or the stile member 36 opposite the distal end 70 of the leg 64, which improves the retention of the leg 64 within the retention channel 48. One having skill in the art will appreciate that the projection 76 may be rounded or any other suitable shape or configuration.

The body 54, the protrusion 62, and the leg 64 may be formed of a polymer. The polymer may be a rigid cellular polyvinyl chloride (PVC). It is to be appreciated the polymer may be any suitable material for engaging the fenestration article 32 and the frame 30.

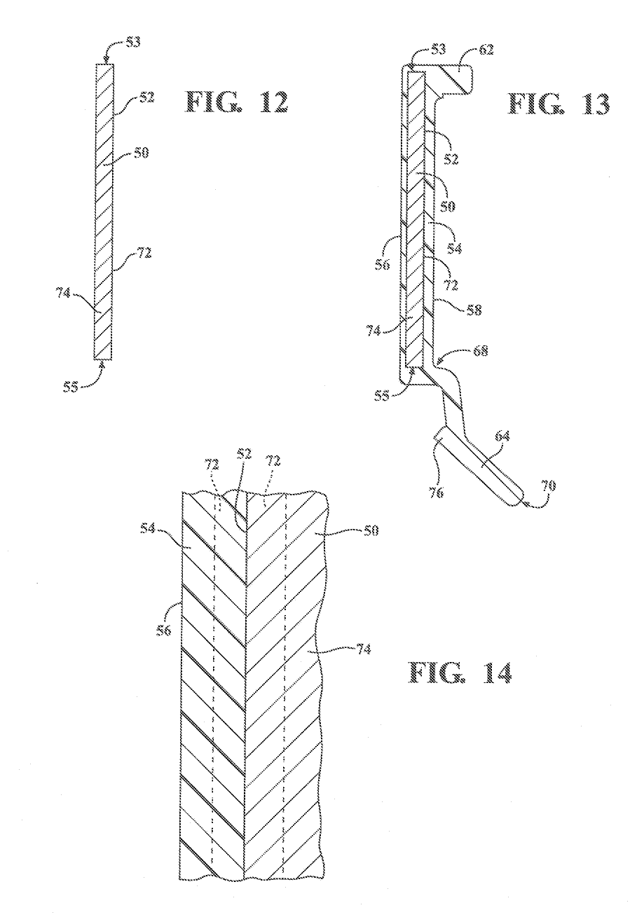

As shown in FIG. 12, the reinforcement member 50 may have a structural layer 74 defining the outer surface 52 and a pretreated layer 72 disposed along at least a portion of the outer surface 52 for improving the coupling of the body 54 with the reinforcement member 50. Said differently, the pretreated layer 72 improves a bond between the reinforcement member 50 and the body 54, which will be further appreciated below. The structural layer 74 may be adjacent the pretreated layer 72.

The pretreated layer 72 may be disposed entirely along the outer surface 52. One having skill in the art will appreciated that the pretreated layer 72 may be disposed along only a portion of the outer surface 52. The pretreated layer 72 may be a thin film or coating disposed along the structural layer 74. Furthermore, the structural layer 74 may be equal-to or between 0.0005 and 0.0015 inches thick. The pretreated layer 72 may be thinner than the structural layer 74. It is to be appreciated that the pretreated layer 72 and the structural layer 74 may be any thickness. The structural layer 74 may be more rigid than the pretreated layer 72 with the structural layer 74 acting as a plastically-deformable skeleton for the glazing bead 28, which allows the glazing bead 28 to be worked into different configurations.

The pretreated layer 72 may comprise a polymer. The polymer facilitates improved coupling between the reinforcement member 50 and the body 54. The polymer may comprise a polyurethane. It is to be appreciated that the pretreated layer 72 may comprise any suitable material.

The structural layer 74 may comprise a metallic material. The metallic material may be at least partially comprised of aluminum. The metallic material may be entirely comprised of aluminum. It is to be appreciated that the metallic material may be a surface-treated aluminum, including but not limited to anodized aluminum. Metallic materials are typically capable of being plastically-deformed, which allows the reinforcement member 50 to be worked into various configurations and to maintain those configurations. The metallic material is also more resistant to heat-related deformation than the body 54, the protrusion 62, and the leg 64, which may be formed of the polymer described above. The glazing bead 28 is commonly subjected to direct heat from the sun. As such, the reinforcement member 50 prevents excessive warping of the glazing bead 28 due to heat.

The pretreated layer 72 and the structural layer 74 may be integral with one another. Said differently, with the body 54 coupled with the outer surface 52 of the reinforcement member 50, the pretreated layer 72 may not be distinguishable from the structural layer 74 of the reinforcement member 50, which is best shown in the magnified view of the coupling of the reinforcement member 50 and the body 54 shown in FIG. 14. When the body 54 is formed along the outer surface 52 (as will be further described below) the pretreated layer 72 may extend into and blends with the structural layer 74 and with the body 54, which improves the coupling between the reinforcement member 50 and the body 54. As such, the pretreated layer 72 and the structural layer 74 may be indistinguishable from one another (i.e., integral).

The cap 60 (as shown in FIGS. 2A-3B and 5A-8) may be formed of an acrylic and provides an aesthetically pleasing visual surface. It is to be appreciated that the cap 60 may be formed of any suitable material having the desired aesthetic characteristics. The cap 60 is disposed on at least the exterior surface 56 of the body 54. The cap 60 may extend to beyond the body 54 to be disposed on the protrusion 62 as shown in FIGS. 2A-3B and 5A-8. The cap 60 may extend to beyond the body 54 to be disposed on the leg 64 as shown in FIGS. 2A-2C. It is to be appreciated that the cap 60 may be disposed along any single or any combination of portions of the body 54, the protrusion 62, and the leg 64. Furthermore, it is to be appreciated that the glazing bead 28 may be without the cap 60, as shown in FIGS. 4A, 4B and 9-11.

The invention further comprises a method of manufacturing the glazing bead 28. The method comprises the steps of providing the reinforcement member 50, and depositing the polymer to form the body 54, the protrusion 62, and the leg 64 coupled with the reinforcement member. Said differently, the polymer of the body 54, the protrusion 62, and the leg 64 is placed into contact with the outer surface 52 with the reinforcement member 50 to couple the reinforcement member 50 with the body 54, the protrusion 62, and the leg 64. Although numerous embodiments of the glazing bead 28 are shown in the Figures, the steps set forth in the described method are illustrated in FIGS. 2B and 12-14 using a single embodiment of the glazing bead 28. It is to be appreciated that the steps illustrated in FIGS. 2B and 12-14 are illustrative in nature and are applicable to all embodiments of the glazing bead 28.

The method may further include the step of depositing the acrylic along the body 54 to form the cap 60. More specifically, the acrylic of the cap 60 may be placed into contact with at least the body 54 to couple the body 54 with the cap 60.

The step of depositing the polymer to form the body 54 may be further defined as depositing the polymer enveloping the reinforcement member 50 to form of the body 54. The reinforcement member 50, prior to the step of depositing the polymer to form the body 54, the protrusion 62, and the leg 64, is shown in FIG. 12. The reinforcement member 50 coupled with the body 54, the protrusion 62, and the leg 64 after the step of depositing the polymer to form the body 54, the protrusion 62, and the leg 64 is shown in FIG. 13. Additionally, the step of depositing the polymer to form the body 54, the protrusion 62, and the leg 64 may be further defined as extruding the polymer to form the body 54, the protrusion 62, and the leg 64.

During extrusion, the reinforcement member 50 is positioned within a die having a mold surface defining a void. The polymer is extruded into the void (i.e., the polymer material, which is typically in a solid state such as a pellet or granule, is heated by compression or radiant heat to a temperature at or between 300 and 360 degrees Fahrenheit). The polymer material converts from the solid state into a liquid state and is moved into and fills the void enveloping the reinforcement member 50. It is to be appreciated that the step of depositing the polymer to form the body 54, the protrusion 62, and the leg 64 may be performed by any other suitable process, including but not limited to injection molding.

The step of providing the reinforcement member 50 may be further defined as providing the reinforcement member 50 having an initial configuration, as shown in FIG. 12. The initial configuration may be a flat and planar configuration. It is to be appreciated that the initial configuration may be any suitable shape, size, composition, etc.

The method may further comprise the step of forming the reinforcement member 50 of the structural layer 74 and the pretreated layer 72. As described above, the structural layer 74 may be the metallic material at least partially comprised of aluminum and the pretreated layer 72 may be the polymer comprised of polyurethane. As described above, the pretreated layer 72 improves the coupling between the reinforcement member 50 and the body 54 with the pretreated layer 72 and the structural layer 74 integral with one another such that the structural layer 74 and the pretreated layer 72 are indistinguishable. The pretreated layer 72 and the structural layer 74 may be integral after the step of depositing the polymer to form the body 54, the protrusion 62, and the leg 64, as shown in FIG. 14. Said differently, the pretreated layer 72 and the structural layer 74 are distinguishable prior to the step depositing the polymer to form the body 54, the protrusion 62, and the leg 64.

The step of forming the reinforcement member 50 of the structural layer 74 and the pretreated layer 72 may occur prior to the step of providing the reinforcement member 50. Furthermore, the step of forming the reinforcement member 50 of the structural layer 74 and the pretreated layer 72 is commonly performed off-site (i.e., not at the same facilities as the steps providing the reinforcement member 50, depositing the polymer to form the body 54, the protrusion 62, and the leg 64 coupled with the reinforcement member, and depositing the acrylic to form the cap 60) and is in-sourced prior to the steps of providing the reinforcement member 50, depositing the polymer to form the body 54, the protrusion 62, and the leg 64 coupled with the reinforcement member and depositing the acrylic to form the cap 60. The reinforcement member 50 may be in-sourced having the flat configuration and is coiled about an axle. The reinforcement member 50 is then un-coiled into the planar configuration prior to the step of providing the reinforcement member 50. It is to be appreciated that the step of forming the reinforcement member 50 may be performed on-site.

The method may further comprise the step of working the reinforcement member 50 into a modified configuration. Said differently, the reinforcement member 50 may be worked into a non-linear configuration, which is generally shown in the embodiment illustrated in FIGS. 7-9 and 11. The step of working the reinforcement member 50 may be further defined as bending the reinforcement member 50 into the modified configuration. Bending involves the application of force to an object to create a curve or an angle from a flat or straight configuration. The step of bending the reinforcement member 50 may be further defined as roll-forming the reinforcement member 50 into the modified configuration. The step of roll-forming may involve a plurality of sets of roller-dies with the reinforcement member 50 passing along each set of roller-dies and with each set of roller dies exerting a force on the reinforcement member 50. The sets of roller-dies progressively bend the reinforcement member 50 from the initial configuration to the modified configuration. It is to be appreciated that the step of working the reinforcement member 50 may be performed by any suitable process, including but not limited to forging and extruding.

The method may further comprise the step of pre-heating the reinforcement member 50 prior to the step of depositing the polymer to form the body 54, the protrusion 62, and the leg 64. The step of pre-heating the reinforcement member 50 may follow the step of working the reinforcement member 50. The step of pre-heating the reinforcement member 50 may involve raising the temperature of the reinforcement member 50 to approximately 300 degrees Fahrenheit. The step of pre-heating the reinforcement member 50 improves integration of the pretreated layer 72 into the structural layer 74 and into the body 54 during the following step of depositing the polymer to form the body 54, the protrusion 62, and the leg 64. It is to be appreciated that the step of pre-heating may involve raising the temperature to any desired temperature.

It is common that following the step of depositing the body 54, the protrusion 62, and the leg 64 (which may occur at or between 300 and 360 degrees Fahrenheit) the polymer of the body 54, the protrusion 62, and the leg 64 may not be cooled to a sufficient temperature within the die of the extruder to maintain the shape of the body 54, the protrusion 62, and the leg 64 defined by the extruder. Furthermore, the reinforcement member 50, which also has an elevated temperature, may change size and shape as its temperature decreases after leaving the die of the extruder. As such, the method may further comprise the step of shaping the reinforcement member 50, the body 54, the protrusion 62, and the leg 64 into a final configuration following the step of depositing the polymer to form the body 54, the protrusion 62, and the leg 64, as shown in FIG. 13. The step of shaping the reinforcement member 50, the body 54, the protrusion 62, and the leg 64 into the final configuration may further comprise the steps of applying a vacuum to the reinforcement member 50, the body 54, the protrusion 62, and the leg 64 within a final die and cooling the reinforcement member 50, the body 54, the protrusion 62, and the leg 64. The steps of applying the vacuum to the reinforcement member 50, the body 54, the protrusion 62, and the leg 64 within the final die and cooling the reinforcement member 50, the body 54, the protrusion 62, and the leg 64 may occur within a cooling tank. The cooling tank has the final die which has a cross-section that is the same as a cross-section of the final configuration of the reinforcement member 50, the body 54, the protrusion 62, and the leg 64. The reinforcement member 50, the body 54, the protrusion 62, and the leg 64 are drawn through the final die which deforms the reinforcement member 50, the body 54, the protrusion 62, and the leg 64 from the modified configuration to the final configuration. The vacuum is applied to the reinforcement member 50, the body 54, the protrusion 62, and the leg 64 within the final die to ensure that the reinforcement member 50, the body 54, the protrusion 62, and the leg 64 are not spaced from an interior surface 58 of the final die.

The step of cooling the reinforcement member 50, the body 54, the protrusion 62, and the leg 64 may occur simultaneously with the step of applying the vacuum to the reinforcement member 50, the body 54, the protrusion 62, and the leg 64 within the final die and may also occur following the step of applying the vacuum to the reinforcement member 50, the body 54, the protrusion 62, and the leg 64 within the final die. The step of cooling the reinforcement member 50, the body 54, the protrusion 62, and the leg 64 may occur following the step of applying the vacuum to the reinforcement member 50, the body 54, the protrusion 62, and the leg 64 within the final die. The step of cooling the reinforcement member 50, the body 54, the protrusion 62, and the leg 64 involves the application of a fluid (typically water, but may be any suitable fluid) along the body 54, the protrusion 62, and the leg 64. The fluid may be applied directly to the body 54, the protrusion 62, and the leg 64. However, the fluid may be applied indirectly to the reinforcement member 50, the body 54, the protrusion 62, and the leg 64 (i.e., the fluid is close to but spaced from the reinforcement member 50, the body 54, the protrusion 62, and the leg 64). The fluid is heated by the reinforcement member 50, the body 54, the protrusion 62, and the leg 64 by heat exchange and is transported away from the reinforcement member 50, the body 54, the protrusion 62, and the leg 64. As such, the fluid cools the reinforcement member 50, the body 54, the protrusion 62, and the leg 64, which maintains the final configuration of the reinforcement member 50, the body 54, the protrusion 62, and the leg 64.

Each of the steps described above may be performed in succession in accordance with the order described above. Said differently, the steps are performed along a production line with components of the glazing bead 28 being introduced and/or defined progressively along the production line. The steps produce a long continuous glazing bead 28 being introduced along the production line. The components of the glazing bead 28 must be driven along the assembly line. Therefore, the method may further comprise the step of pushing the reinforcement member 50 having the initial configuration along the production line. This step may be performed prior to the step of depositing the polymer to form the body 54, the protrusion 62, and the leg 64. The coil of the reinforcement member 50 may be driven by the axle. Said differently, the axle rotates which both uncoils the reinforcement member 50 and pushes the reinforcement member 50 along the production line. Therefore, the step of pushing the reinforcement member 50 may be performed when the reinforcement member 50 is in the initial configuration.

The step of pushing the reinforcement member 50 having the initial configuration along the production line may be sufficient to move the reinforcement member 50 entirely along the production line. However, the forces exerted on the reinforcement member 50 during the step of depositing the polymer to form the body 54, the protrusion 62, and the leg 64 and the potential steps of working the reinforcement member 50 into the modified configuration and applying the vacuum to the reinforcement member 50, the body 54, the protrusion 62, and the leg 64 within the final die may apply an opposing force against the force exerted by the driven axle. Therefore, the method may further comprise the step of pulling the reinforcement member 50, the body 54, the protrusion 62, and the leg 64 having the final configuration along the production line. This step may be performed following the step of shaping the reinforcement member 50, the body 54, the protrusion 62, and the leg 64 into the final configuration. A pulling device may be positioned down the assembly line following the cooling tank. Therefore, the step of pulling the reinforcement member 50, the body 54, the protrusion 62, and the leg 64 may be performed when the reinforcement member 50, the body 54, the protrusion 62, and the leg 64 6 is in the final configuration. The pulling device grips the reinforcement member 50, the body 54, the protrusion 62, and the leg 64 having the final configuration coming out of the cooling tank and exerts a force away from the cooling tank. Therefore, the steps of pushing the reinforcement member 50 and pulling the reinforcement member 50, the body 54, the protrusion 62, and the leg 64 exert forces acting in the same direction which facilitates movement of the reinforcement member 50, the body 54, the protrusion 62, and the leg 64 down the production line.

The step of depositing the acrylic to form the cap 60 may occur after the reinforcement member 50, the body 54, the protrusion 62, and the leg 64 are deposited, and is generally shown in FIG. 2B. The step of depositing the acrylic to form the cap 60 may be further defined as the step of extruding the acrylic to form the cap 60. The extrusion may occur within the die in which the polymer was extruded to form the body 54, the protrusion 62, and the leg 64. The acrylic may be extruded into the void through a second flow channel at least the body 54. The extrusion of the acrylic may occur after the extrusion of the polymer. It is to be appreciated that the extrusion of the acrylic and the extrusion of the polymer may occur simultaneously. It is to be appreciated that the acrylic may be deposited in any suitable manner and at any sequence in the method. Furthermore, the step of shaping the reinforcement member 50, the body 54, the protrusion 62, and the leg 64 into a final configuration may be further defined as the step of shaping the reinforcement member 50, the body 54, the protrusion 62, the leg 64, and the cap 60 into a final configuration.

The method may further comprise the step of cutting the reinforcement member 50, the body 54, the protrusion 62, the leg 64, and the cap 60 to create the glazing bead 28. Said differently, the reinforcement member 50, the body 54, the protrusion 62, the leg 64, and the cap 60 are cut transverse to the longitudinal axis L such that the glazing bead 28 has a length, as shown in FIG. 1.

The invention has been described in an illustrative manner, and it is to be understood that the terminology which has been used is intended to be in the nature of words of description rather than of limitation. As is now apparent to those skilled in the art, many modifications and variations of the subject invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A glazing bead for engaging a fenestration article and a frame, said glazing bead comprising:
a reinforcement member having an outer surface and extending along a longitudinal axis between a pair of longitudinal ends, with at least a portion of said reinforcement member extending along a cross-sectional axis, which is transverse to said longitudinal axis, in a substantially linear configuration between a first end and a second end;
a body at least partially enveloping said outer surface of said reinforcement member and coupled with said reinforcement member, with said body supported by said reinforcement member;
a protrusion extending from said body adjacent said first end of said reinforcement member for engaging the fenestration article; and
a leg having a proximal end adjacent said second end of said reinforcement member, with said leg extending from said body to a distal end, with said proximal and distal ends forming an angle less than ninety degrees from said cross-sectional axis for engaging the frame such that said leg is retained by the frame.

2. The glazing bead as set forth in claim 1, wherein said body has an exterior surface configured to face away from the fenestration article and an interior surface configured to face toward the fenestration article such that said interior surface opposes said exterior surface along said cross-sectional axis, and further including a cap disposed on said exterior surface of said body for covering said body when said glazing bead engages the fenestration article and the frame.

3. The glazing bead as set forth in claim 1, wherein said reinforcement member has a structural layer defining said outer surface and a pretreated layer disposed along at least a portion of said outer surface for improving said coupling of said body with said reinforcement member.

4. The glazing bead as set forth in claim 2 wherein said pretreated layer is disposed entirely along said outer surface.

5. The glazing bead as set forth in claim 1, wherein said pretreated layer comprises a polymer.

6. The glazing bead as set forth in claim 3, wherein said structural layer comprises a metallic material.

7. The glazing bead as set forth in claim 3, wherein said pretreated layer and said structural layer are integral with one another.

8. The glazing bead as set forth in claim 1, wherein said body has an exterior surface configured to face away from the fenestration article and an interior surface configured to face toward the fenestration article, such that said interior surface opposes said exterior surface along said cross-sectional axis, with said protrusion extending from said interior surface.

9. The glazing bead as set forth in claim 8, wherein said leg extends from said interior surface.

10. The glazing bead as set forth in claim 1, wherein said leg is angled outwardly away from said body.

11. The glazing bead as set forth in claim 1, wherein said leg is angled inwardly toward first end of said reinforcement member.

12. The glazing bead as set forth in claim 1, wherein said leg has a plurality of portions integral with one another and extending in series between said proximal and distal ends with said portions positioning said distal end relative to said proximal end and with said proximal and distal ends forming said angle.

13. The glazing bead as set forth in claim 1, wherein said leg has a projection between said proximal and distal ends, with said projection opposing said distal end for engaging the frame with each at each of said distal end and said projection.

14. A fenestration closure assembly for disposition within an opening of a structure, said fenestration closure assembly comprising:
a frame;
a fenestration article coupled to said frame; and
a glazing bead engaged with said fenestration article and said frame, said glazing bead comprising:
a reinforcement member having an outer surface and extending along a longitudinal axis between a pair of longitudinal ends, with at least a portion of said reinforcement member extending along a cross-sectional axis, which is transverse to said longitudinal axis, in a substantially linear configuration between a first end and a second end;
a body at least partially enveloping said outer surface of said reinforcement member and coupled with said reinforcement member, with said body supported by said reinforcement member;
a protrusion extending from said body adjacent said first end of said reinforcement member and engaged with said fenestration article; and
a leg having a proximal end adjacent said second end of said reinforcement member, with said leg extending from said body to a distal end, with said proximal and distal ends forming an angle less than ninety degrees from said cross-sectional axis to engage said frame such that said leg is retained by said frame.

15. A method of manufacturing a glazing bead for engaging a fenestration article and a frame, with the glazing bead including a reinforcement member having an outer surface and extending along a longitudinal axis between a pair of longitudinal ends, with at least a portion of the reinforcement member extending along a cross-sectional axis, which is transverse to the longitudinal axis, in a substantially linear configuration between a first end and a second end, a body at least partially enveloping the outer surface of the reinforcement member and coupled with the reinforcement member, with the body supported by the reinforcement member, and a leg having a proximal end adjacent the second end of the reinforcement member, with the leg extending from the body to a distal end, with the proximal and distal ends forming an angle less than ninety degrees from the cross-sectional axis; said method comprising the steps of:
providing the reinforcement member; and
depositing a polymer to form the body, the protrusion, and the leg coupled with the reinforcement member.

16. The method as set forth in claim 15, further including the step of depositing an acrylic along the body to form a cap.

17. The method as set forth in claim 15, wherein the step of depositing the polymer to form the body is further defined as depositing the polymer enveloping the reinforcement member to form of the body.

18. The method as set forth in claim 15, wherein the step of depositing the polymer to form the body, the protrusion, and the leg is further defined as extruding the polymer to form the body, the protrusion, and the leg.

19. The method as set forth in claim 15, wherein the step of providing the reinforcement member is further defined as providing the reinforcement member having an initial configuration, and further including the step of working the reinforcement member into a modified configuration.

20. The method as set forth in claim 19, wherein the step of working the reinforcement member is further defined as roll-forming the reinforcement member into the modified configuration.

21. The method as set forth in claim 15, further including the step of pre-heating the reinforcement member prior to the step of depositing the polymer to form the body, the protrusion, and the leg.

22. The method as set forth in claim 15, further including the step of shaping the reinforcement member, the body, the protrusion, and the leg into a final configuration following the step of depositing the polymer to form the body, the protrusion, and the leg.

23. The method as set forth in claim 22, wherein the step of shaping the reinforcement member, the body, the protrusion, and the leg into the final configuration further includes the steps of applying a vacuum to the reinforcement member, the body, the protrusion, and the leg within a final die and cooling the reinforcement member, the body, the protrusion, and the leg.
